(19) United States
(12) Patent Application Publication
(10) Pub. No.: US 2020/0115061 A1
(43) Pub. Date: Apr. 16, 2020

(54) UNMANNED AERIAL VEHICLE AND AIRBAG DEVICE THEREOF

(71) Applicant: PRODRONE CO., LTD., Nagoya-shi, Aichi (JP)

(72) Inventors: Kenji TAKEUCHI, Chita-gun (JP); Kiyokazu SUGAKI, Nagoya-shi (JP); Masahiko SUGIMOTO, Nagoya-shi (JP)

(73) Assignee: PRODRONE CO., LTD., Nagoya-shi, Aichi (JP)

(21) Appl. No.: 16/489,537

(22) PCT Filed: Mar. 19, 2018
(86) PCT No.: PCT/JP2018/010723

§ 371 Date: Aug. 28, 2019

(30) Foreign Application Priority Data
Mar. 22, 2017 (JP) 2017-056310

(51) Int. Cl. B64D 25/00; B64C 39/02; G01C 15/00

(52) U.S. Cl. CPC B64D 25/00; B64C 39/024; B64C 2201/123; B64C 2201/027; B64C 2201/108; G01C 15/002

(57) ABSTRACT

An unmanned aerial vehicle includes: a plurality of rotary wings; a load object disposed on an airframe of the unmanned aerial vehicle, the load object being an external device or a piece of goods disposed at an outside of the airframe; and an air bag device configured to protect the external device. The air bag device includes: a sensor configured to detect a collision and/or a fall of the airframe; an air bag inflatable by a supply of gas; and an inflator configured to supply the gas to the air bag. The air bag includes a plurality of buffers each being a bag body inflatable into an approximately columnar shape. The plurality of inflated buffers are aligned in their radial direction such that the plurality of inflated buffers cover an outer surface of the load object.

### TECHNICAL FIELD

The present invention relates to a technique of protecting an article incorporated in an unmanned aerial vehicle.

### BACKGROUND ART

Patent literature 1 below discloses an unmanned aerial vehicle equipped with an air bag device.

### CITATION LIST

### Cited Literature

PTL1: JP 6-127483 A

### SUMMARY OF INVENTION

### Technical Problem

Small-size unmanned aerial vehicles represented by industrial unmanned helicopters have had airframes too expensive to be affordable. Also, these vehicles used to require skillful pilotage for stable flight. In recent years, however, there have been improvements and cost reductions in sensors and software used to control Posture of unmanned aerial vehicles and to implement autonomous flight of unmanned aerial vehicles. This has led to considerable improvement in manipulability of unmanned aerial vehicles. In particular, small size multi-copters are simpler in rotor structure than helicopters and thus easier to design and maintain. As such, small size multi-copters are not only used for hobbyist purposes but also applied to various missions in a wide range of fields.

As unmanned aerial vehicles are applied in a wider range of industrial field unmanned aerial vehicle have started to be equipped with significantly expensive devices such as laser scanners. If an unmanned aerial vehicle equipped with such device falls to a ground due to an unexpected external disturbance or a flight control error, huge economic loss may result.

In light of the above-described problems, a problem to be solved by the present invention provide an unmanned aerial vehicle that eliminates or minimizes damage to a load object with which the unmanned aerial vehicle is equipped, even if a trouble such as a collision and a fall occurs while the unmanned aerial vehicle is making a flight.

### Solution to Problem

In order to solve the above-described problem, an unmanned aerial vehicle according to the present invention includes: a plurality of rotary wings; a load object disposed on an airframe of the unmanned aerial vehicle, the load object being an external device or a piece of goods disposed at an outside of the airframe; and an air bag device configured to protect the load object. The air bag device includes: a sensor configured to detect a collision and/or a fall of the airframe; an air bag inflatable by a supply of gas; and an inflator configured to supply the gas to the air bag. The air bag includes a plurality of buffers each being a bag body inflatable into an approximately columnar shape. The plurality of inflated buffers are aligned in their radial direction such that the plurality of inflated buffers cover an outer surface of the load object.

In the air bag device according to the present invention, the load object is covered not by greatly inflating a single bag body but by aligning a plurality of bag bodies (buffers) smaller in unit. In this manner, the load object is protected from impact of a collision on an object such as the ground. The configuration in which the air bag is made up of a plurality of bag bodies ensures that gas can be supplied to these bag bodies simultaneously, and that the total amount of gas necessary for completely inflating the air bag is kept at a low amount, as compared with cases where a single bag body is used. Additionally, the above configuration reduces the number of foldings of the bag bodies at the time when the bag bodies are stored, as compared with the numerousness of the number of foldings of a single bag body at the time then the single bag body is stored. That is, the above configuration reduces the inflation pressure necessary for inflating the air bag. This ensures that in the air bag device according to the present invention, the period of time necessary for inflating the air bag is shortened, making the load object protected more reliably.

Preferably, at least one end portion of each buffer of the plurality of buffers is tapered, and a vicinity portion of the each buffer near the one end portion is curved or bent toward the load object.

Thus, at least one end portion of each buffer is curved or bent toward the load object. This ensures that when, for example, these buffers are inflated and aligned along a side surface of the load object in a vertical direction, the end portions of the buffers wrap around the front surface or the rear surface of the load object, thereby directly protecting the front surface or the rear surface. In this respect, forming these end portions in tapered shapes eliminates or minimizes contact and/or interference between the end portions of buffers, ensuring that the buffers are arranged in an orderly manner.

Preferably, the one end portion and another end portion of the each buffer are tapered, and vicinity portions of the each buffer near the one end portion and the another end portion are curved or bent toward the load object.

Thus, both end portions of the each buffer are curved or bent toward the load object. This ensures that when, for example, these buffers are inflated and aligned along a side surface of the load object in a vertical direction, the end portions of the buffers wrap around the front surface and the rear surface of the load object, thereby directly protecting the front surface and the rear surface. In this respect, forming these end portions in tapered shapes eliminates or minimizes contact and/or interference between the end portions of buffers, ensuring that the buffers are arranged in an orderly manner.

Preferably, the plurality of buffers in uninflated state are folded and stored in a plurality of storages, and the plurality of storages are oriented in a same direction and disposed at positions where the plurality of storages are line-symmetrical to each other with respect to, as a reference, an imaginary line passing through the load object.

Thus, storages for the buffers are provided, at a plurality of positions around the load object. This shortens the distance over which the each buffer moves at the time when the air bag is inflated. In this respect, these storages are disposed at positions where the storages are line-symmetrical to each other with respect to the load object. This promotes commonization in shape and structure of the buffers and the storages, and ensures that the outer surface of the load object covered by the buffers can be protected with uniform buffer strength.

Preferably, the plurality of buffers in uninflated state are folded and stored in a storage; the storage is a case body having such a structure that a pair of case hemi-segments are bound to each other with a catch; and the catch has such a binding strength that the catch is releasable by inflation pressure of the plurality of buffers.

Thus, a catch adjusted to be releasable by the inflation pressure of the buffers is used as binding means for binding the case hemi-segments constituting the storage. This ensures that a simple structure is used to realize both storage of non-operated buffers and quick inflation of the buffers.

Preferably, the air bag device includes a partition that is a rigid member for regulating an inflation direction of each buffer of the plurality of buffers.

Thus, the air bag includes a partition. This ensures that the inflation direction of the each buffer is kept under control, optimizing the positions of the buffers at inflation time. This enables the air bag to stably exhibit its inherent protection performance.

Also, the partition may be inserted between one buffer of the plurality of buffers and another buffer of the plurality of buffers adjacent to the one buffer.

Thus, the partition is inserted between one buffer and another buffer. This ensures that the buffers on both sides of the partition inflate toward the both sides of the partition. That is, reference positions at which the inflated buffers are arranged are specified.

Preferably, the inflator includes: a gas canister filled with the gas; a needle unit biased toward a sealed outlet of the gas canister; a locking piece configured to lock movement of the needle unit; and a servo motor configured to move the locking piece. When the sensor has detected the collision and/or the fall of the airframe, the air bag device is preferably configured to drive the servo motor in one direction to release a locked state of the needle unit.

Thus, the control motion performed at the time when the air bag is inflated is only the driving of the servo motor in one direction, causing the ever-biased needle unit to break the sealed outlet of the gas canister so that the gas is supplied into the air bag. This makes the air bag inflate immediately after the sensor has detected an abnormality.

Preferably, the sensor is a sensor dedicated to the air bag device and different from a sensor with which the airframe is equipped, and the air bag device includes a motive power source that is dedicated to the air bag device and that is different from a motive power source with which the airframe is equipped.

When an abnormality has occurred in the airframe of the unmanned aerial vehicle, it is possible that an instrument and/or a motive power source provided in the airframe is not operating normally. The configuration in which the air bag device is provided with a dedicated abnormality detection sensor and a dedicated motive power source ensures that the load object is protected more reliably.

Preferably, the load object is a laser scanner configured to measure a topography.

The unmanned aerial vehicle according to the present invention exhibits its technical significance especially when the unmanned aerial vehicle is equipped with an expensive device.

### Advantageous Effects of Invention

Thus, the unmanned aerial vehicle and the airbag device thereof according to the present invention eliminate or minimize damage to a load object with which the unmanned aerial vehicle is equipped, even if a trouble such as a collision and a fall occurs while the unmanned aerial vehicle is making a flight.

### BRIEF DESCRIPTION OF DRAWINGS

FIG. 1 is a perspective view of an exterior of a multi-copter according to an embodiment.

FIG. 2 is a side view of the multi-copter as seen from S direction illustrated in FIG. 1.

FIG. 3 is a perspective view of the multi-copter with the air bag inflated.

FIG. 4 is a schematic illustrating a structure of buffers.

FIG. 5 is a plan view of an exterior of an air bag device.

FIG. 6 is a schematic cross-sectional view of an inflator illustrating a structure of the inflator.

FIG. 7 is a block diagram illustrating a mechanism configuration of the multi-copter.

### DESCRIPTION OF EMBODIMENTS

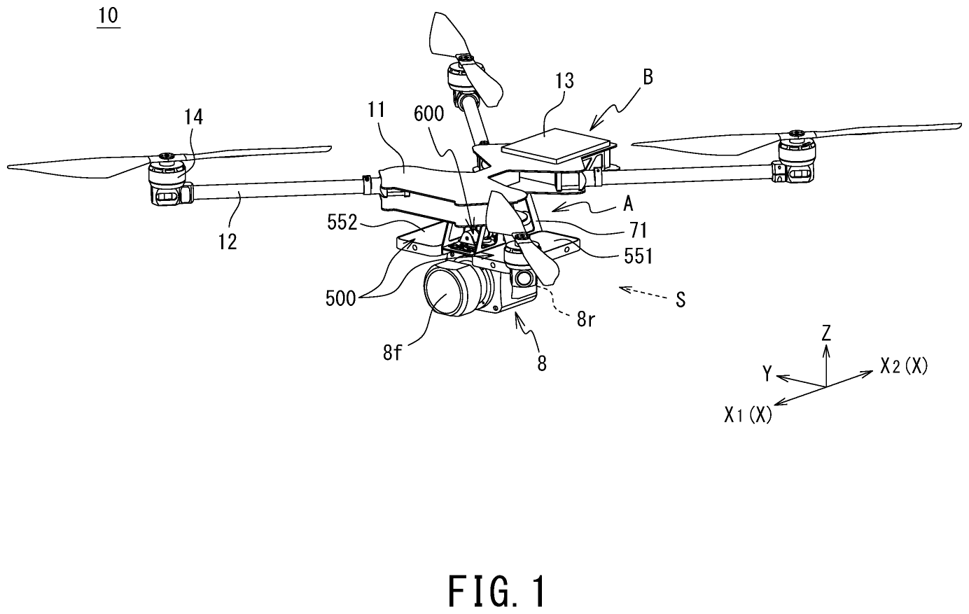

An embodiment of the present invention will be described below by referring to the accompanying drawings. The embodiment that will be described below is an example in which the airframe of a multi-copter, which is a kind of unmanned aerial vehicle, is provided with the air bag device according to the present invention and a laser scanner, which is an external device. As used herein, the terms “upper” and “lower” refer to directions parallel to the Z axis of the coordinate system representation illustrated in FIG. 1. Also as used herein, the term “horizontal” refers to the X-Y plane directions of the coordinate system representation. Also as used herein, the terms “front” and “rear” refer to directions parallel to the X axis of the coordinate system representation. In this example, the X₁ direction corresponds to the “front” direction, and the X₂ direction corresponds to the “rear” direction. Also as used herein, the terms “right and left” and “side” refer to directions parallel to the Y axis of the coordinate system representation.

### [Configuration Outline]

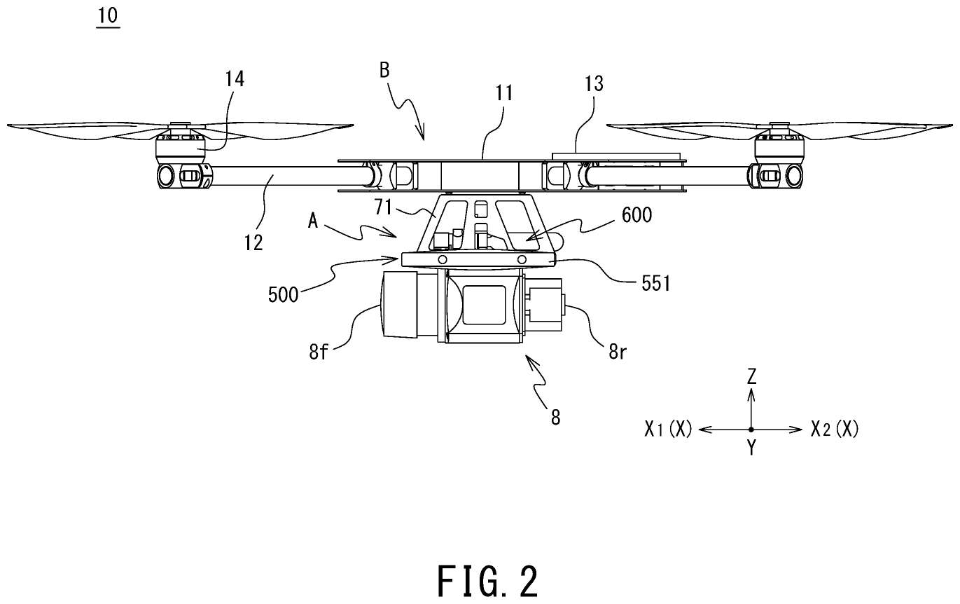

FIG. 1 is a perspective view of an exterior of a multi-copter 10. FIG. 2 is a side view of the multi-copier 10 as seen from the S direction illustrated in FIG. 1.

An airframe B of the multi-copter 10 of this example mainly includes: a center hub 11, which is the body of the airframe B; four arms 12, which radially extend from the center hub 11; a rotor 14, which is disposed at the leading end of each of the arms 12; and a control box 13, which is mounted on the center hub 11. The control box 13 is a controller that controls flight motions of the airframe B.

On the airframe B, a laser scanner 8, which is an external device, is mounted. The laser scanner 8 is disposed on the outside of the airframe B, and in this example, is supported at a lower portion of the airframe B. The laser scanner 8 is a typical laser scanner used for measuring purposes; the laser scanner 8 emits laser light, measures its distance from a ground feature based on the waveform of a reflection of the laser light, and obtains three-dimensional point group data of a topography.

The multi-copter 10 further includes an air bag device A, which protects the laser scanner 8. The air bag device A includes: a stored-gas inflator 600; an air bag 500, which is inflatable and inflatable by a supply of gas from the inflator 600; and a frame 71, which is a frame structure supporting the inflator 600 and the air bag 500. The air bag 500 in uninflated state is stored in folded state in storage cases 551 and 552, which are storages of the air hag 500.

The air bag device A of this example is disposed between the airframe B of the multi-copter 10 and the laser scanner 8. The upper surface of the frame 71 of the air bag device A is connected to the lower surface of the airframe B, and the lower surface of the frame 71 is connected to the upper surface of the laser scanner 8. That is, the laser scanner 8 of this example is mounted on the airframe B via the frame 71 of the air bag device A.

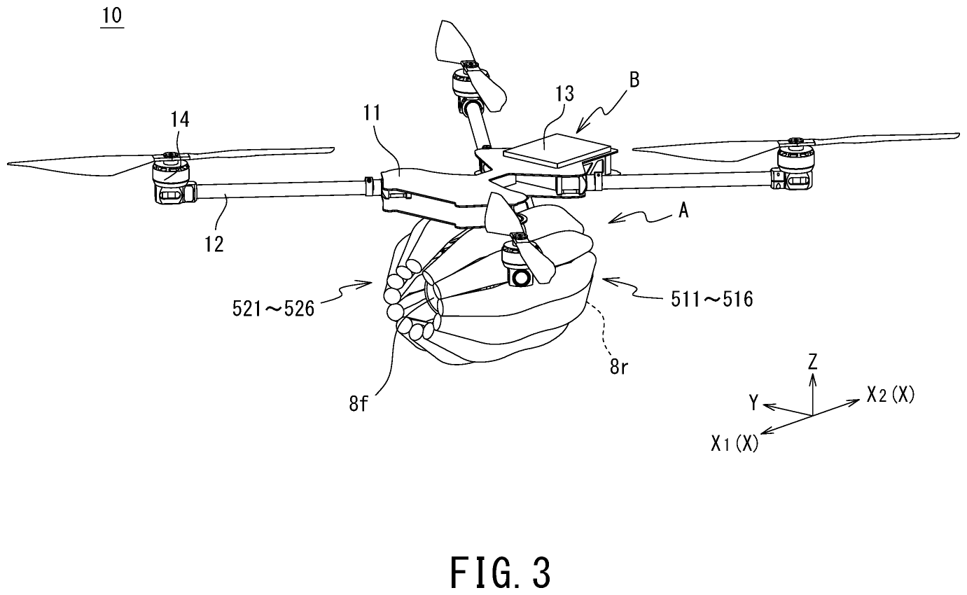

FIG. 3 is a perspective view of the air bag 500 in the storage cases 551 and 552 with the air bag 500 in inflated state. Upon detection of a collision and/or a fall of the airframe B, the air bag device A operates the inflator 600 to inflate the air bag 500. The air bag 500 includes 12 buffers 511 to 516 and 521 to 526, each of which is a bag body inflatable into an approximately columnar shape. The buffers are aligned in their radial direction such that the buffers cover the outer surface of the laser scanner 8.

Thus, in the air bag device A of this example, the laser scanner 8 is covered not by greatly inflating a single bag body but by aligning a plurality of bag bodies (the buffers 511 to 516 and 521 to 526) smaller in unit. In this manner, the laser scanner 8 is protected from impact of a collision on an object such as the ground. In the air bag device A of this example, the air bag 500 is made up of a plurality of bag bodies. This ensures that gas can be supplied to these bag bodies simultaneously, and that the total amount of gas necessary for completely inflating the air bag 500 is kept at a low amount, as compared with cases where a single bag body is used. This ensures that the period of time necessary for inflating the air bag 500 is shortened, making the laser scanner 8 protected more reliably.

It is to be noted that the external device mountable on the multi-copter 10 will not be limited to the laser scanner 8; any other external devices are mountable on the multi-copter 10. Further, the load object disposed on the multi-copter 10 will not be limited to external devices; the load object may be pieces of goods.

### [Air Bag Structure]

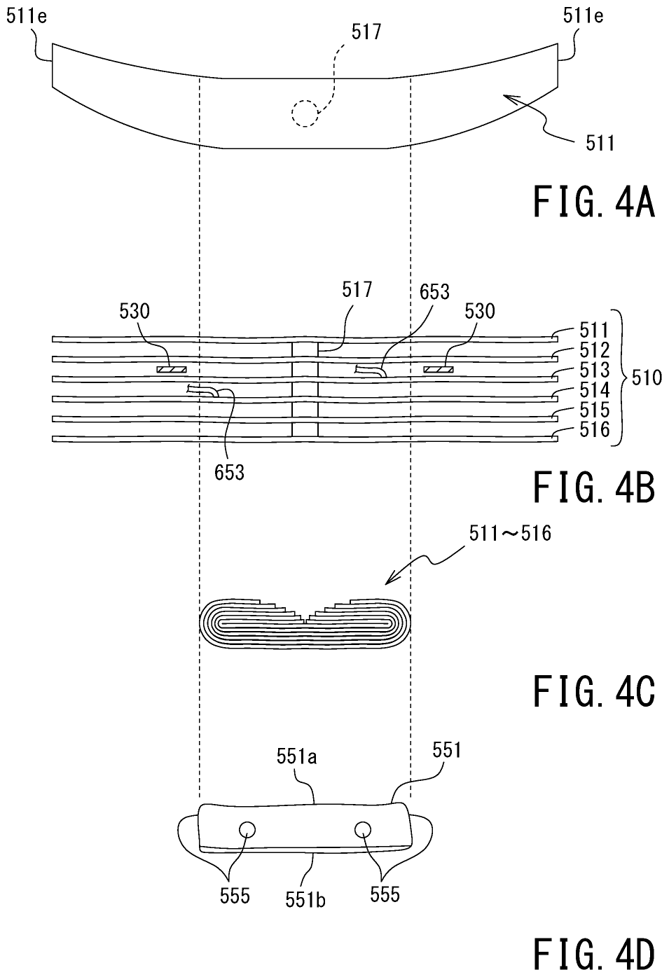

By referring to FIG. 4, a structure of the air bag 500 will be described below. It is to be noted that FIG. 4 is concerning the buffers 511 to 516 (these will be occasionally collectively referred to as “buffers 510”) and a storage case 551, which stores the buffers 510, the structures and features illustrated in FIG. 4 also apply in the buffers 521 to 526 and a storage case 552.

FIG. 4A is a plan view of a shape of a non-inflated buffer 511. It is to be noted that each of the buffers 512 to 516 has the same shape as the shape of the buffer 511.

The buffer 511 is made by welding a fabric such as nylon (polyamide) fiber and polyester fiber onto a bag body having an approximately columnar shape. The total length of the buffer 511 in its longitudinal direction is longer than the length of the laser scanner 8 in its front-rear direction. Both end portions e of the buffer 511 extend further forward than a front surface 8f of the laser scanner 8 and extend further rearward than a rear surface 8r of the laser scanner 8.

As illustrated in FIG. 4A, both end portions 511e of the buffer 511 are tapered, and vicinity portions of the buffer 511 near these end portions 511e are gently curved toward the laser scanner 8. This ensures that when the buffer 511 is inflated, these end portions 511e wrap around the front surface 8f and the rear surface 8r of the laser scanner 8, so that the front surface 8f and the rear surface 8r are directly protected by the end portions e. Also, the configuration in which these end portions 511e are tapered eliminates or minimizes contact and/or interference between the end portions e of the buffers 510, and ensures that the buffers 510 are arranged in an orderly manner with no or minimal gaps (see FIG. 3).

It is to be noted that while in this example the both end portions 511e of the buffer 511 are tapered and curved toward the laser scanner 8, any one of the end portions 511e may be tapered and curved toward the laser scanner 8. In this case, any one of the front surface 8f and the rear surface 8r of the laser scanner 8 can be protected. Another possible example is that the buffer 510 has a uniform diameter throughout its length and has a linear columnar shape, without curving or bending. In this case, insofar as the both end portions of the buffer 510 in its longitudinal direction extend further forward than the front surface 8f of the laser scanner 8 or extend further rearward than the rear surface 8r of the laser scanner 8, the front surface 8f and the rear surface 8r of the laser scanner 8 can be protected from a collision against a plane surface.

FIG. 4B is a side view of non-inflated buffers 510. As illustrated in FIG. 4B. The buffers 511 to 516 include a connection path 517 approximately at the center of each buffer. The connection path 517 is a tube that connects these buffers 511 to 516 to each other. The buffer 513 and the buffer 514 are each connected with a gas tube 653 so that gas released from the inflator 600 passes through the gas tubes 653 to fill the buffer 513 and the buffer 514. The gas filling the buffer 513 and the buffer 514 passes through the connection path 517 to reach all the buffers 510.

A pair of partitions 530 are disposed between the buffer 512 and the buffer 513, which is next to the buffer 512. The pair of partitions 530 are rigid members for regulating the inflation directions of the buffers 511 to 516.

The partitions 530 of this example are integral to the frame 71, and the positions of the partitions 530 are such that the partitions 530 are fixed to the frame 71 unmovably relative to the frame 71. With this configuration, when the buffers 510 are inflated, the positions of the partitions 530 serve as a reference to ensure that the buffer 511 and the buffer 512 inflate in the upper direction while the buffers 513 to 516 inflate in the lower direction. That is, in the air bag 500 of this example, the partitions 530 control the inflation directions of the buffers 511 to 516 so that the buffers 511 to 516 are disposed at optimal positions when the air bag 500 is inflated. This enables the air bag 500 of this example to stably exhibit its inherent protection performance.

It is to be noted that while the partitions 530 of this example are two flat plate portions aligned in the horizontal direction, this is not intended as limiting the form of the partitions according to the present invention. The partitions according to the present invention are rigid members capable of regulating the inflation directions of the buffers, examples including a single planar member and a plurality of round bar members. Also, the partitions may be disposed at any other positions depending on the shapes, number, and/or properties of the buffers insofar as the buffers exhibit their protection performance as desired.

FIG. 4C is a side view of the buffers 510 in folded state. As illustrated in FIG. 4C, when the buffers 510 are stored, it is only necessary to fold both end portions of each buffer 510. That is, a smaller amount of inflation pressure is necessary for inflating the air bag 500, as compared with the numerousness of the number of foldings of a single bag body. This configuration, as well, shortens the period of time necessary for inflating the air bag 500.

FIG. 4D is a side view of the buffers 510 stored in the storage case 551. As illustrated in FIG. 4D, the storage case 551 of this example has such a structure that an upper case 551a and a lower 551b, which are a pair of fabric case hemi-segments, are fastened together with snap buttons 555, which are catches. The snap buttons 555 are adjusted at such a binding strength that the snap buttons 555 are releasable by the inflation pressure of the buffers 510. Thus, the snap buttons 555 are used as binding means for binding the upper case 551a and the lower 551b. This ensures that a simple structure is used to realize both storage of the buffers 510 and quick inflation of the buffers 510.

In a view from a direction toward the front surface of the laser scanner 8, the storage cases 551 and 552 are oriented in the same direction and disposed at positions where the storage cases 551 and 552 are line-symmetrical to each other with respect to, as a reference, an imaginary line passing through the center of the laser scanner 8 in the vertical directions (see FIGS. 1 and 2). Thus, the plurality of storage cases 551 and 552 are disposed at a plurality of positions around the laser scanner 8. This configuration shortens the distance over which each of the buffers 511 to 516 and 521 to 526 moves when the air bag 500 is inflated. The above configuration also ensures commonization in shape and structure of the storage cases 551 and 552 and the buffers 511 to 516 and 521 to 526, and ensures that the outer surface of the laser scanner 8 can be protected with uniform buffer strength.

### [Inflator Structure]

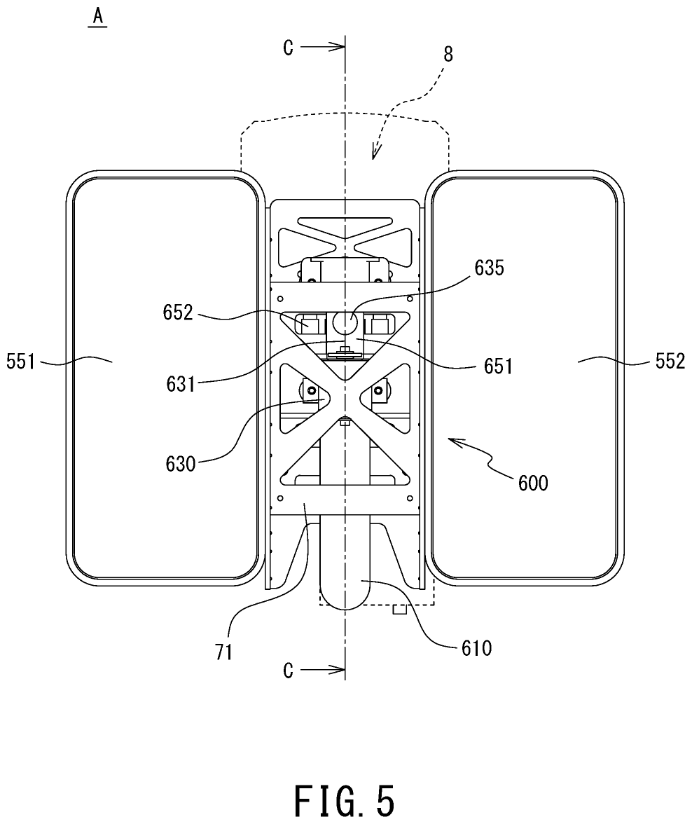

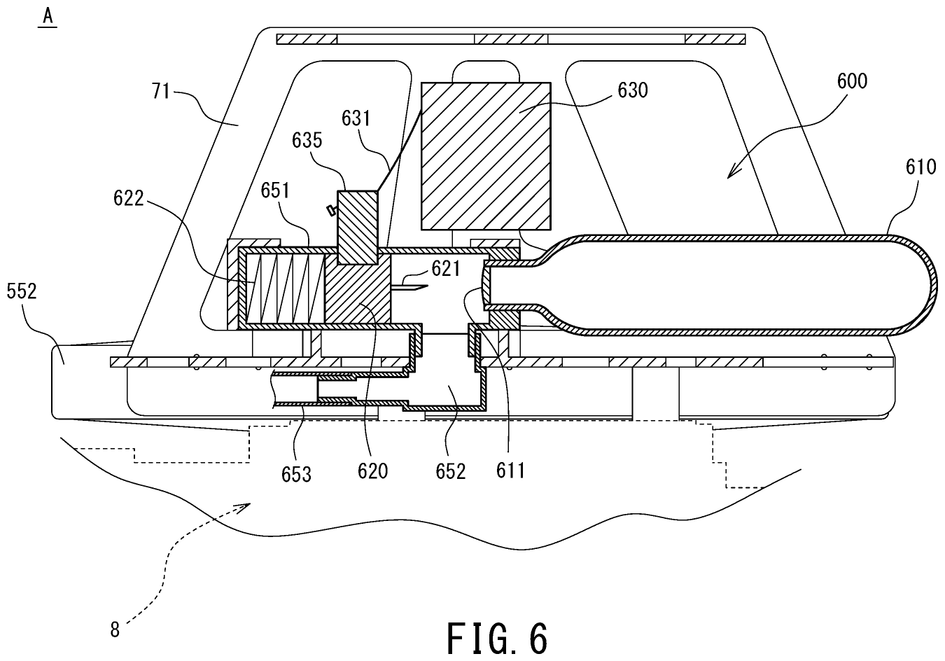

FIG. 5 is a plan view of an exterior of the air bag device A. FIG. 6 is a schematic cross-sectional view of the inflator 600 taken in the direction indicated by C-C in FIG. 5.

By referring to FIG, 6, a structure of the inflator 600 will be described below. The inflator 600 of this example mainly includes: a gas canister 610, which is filled with pressurized carbon dioxide gas; a needle unit 620, which includes a needle 621, which breaks a sealed outlet 611 of the gas canister 610; a coil spring 622, which biases the needle unit 620 toward the sealed outlet 611 of the gas canister 610; a locking piece 635, which is fitted in the outer surface of the needle unit 620 and locks the movement of the needle unit 620; and a servo motor 630, which pulls the locking piece 635 out of the needle unit 620.

The sealed outlet 611 of the gas canister 610, the needle unit 620, and the coil spring 622 are housed in a sealed case 651, which is made of metal. The sealed case 651 is connected with branching sockets 652, which branch the path of the gas released into the sealed case 651 into a plurality of paths. The branching sockets 652 of this example are connected with four gas tubes 653. As described earlier, the gas tubes 653 are connected to the air bag 500.

When the inflator 600 is turned into operation, the servo motor 630 is driven in one direction to cause a wire 631, which is connected to the servo motor 630, to pull the locking piece 635 out of the needle unit 620. Upon release from the locked state, the needle unit 620 is forced to move by the coil spring 622, causing the needle 621 to break the sealed outlet 611 of the gas canister 610. This causes the carbon dioxide gas in the gas canister 610 to be released into the sealed case 651. Then, the released carbon dioxide gas passes through the branching sockets 652 and the gas tubes 653 to fill the air bag 500.

In the air bag device A of this example, the control motion performed at the time when the air bag 500 is inflated is only the driving of the servo motor 630 in one direction, causing the ever-biased needle unit 620 to break the sealed outlet 611 of the gas canister 610 so that the gas is supplied into the air bag 500. This ensures that the air bag 500 is quickly inflated with a minimal number of steps.

### [Function Configuration]

### (Flight Mechanism)

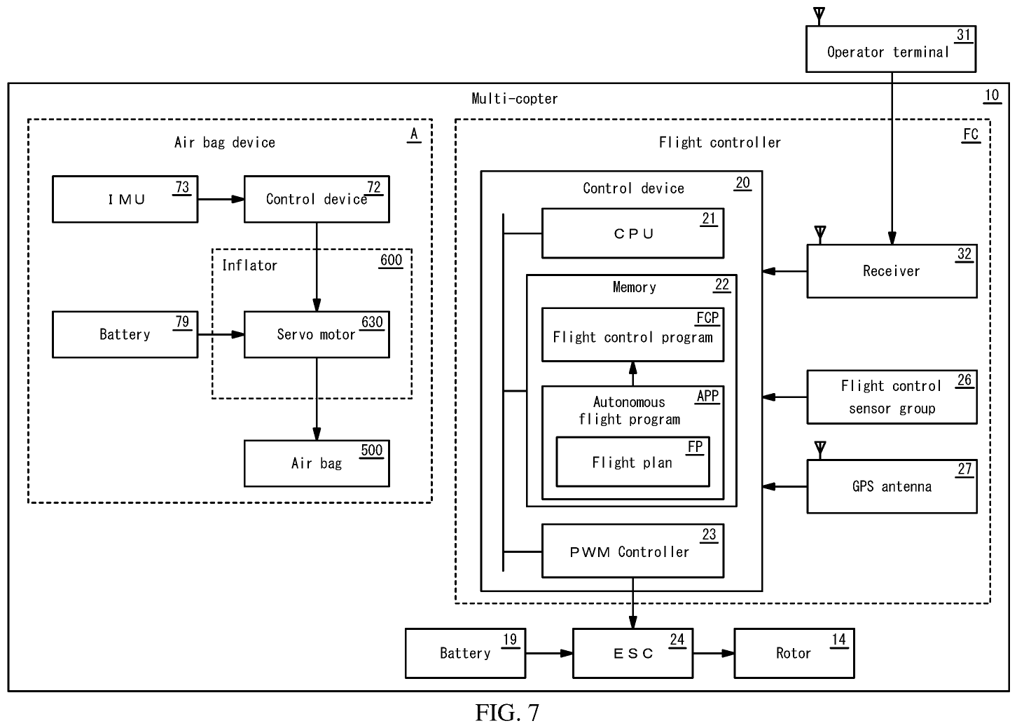

FIG. 7 is a block diagram illustrating a mechanism configuration of the multi-copter 10. The flight functions of the multi-copter 10 mainly include: a flight controller FC; a receiver 32; the rotors 14, which are four rotary wings; an ESC 24 (Electric Speed Controller), which is provided in each of the rotors 14; and a battery 19, which supplies power to the foregoing elements. Basic flight functions of the multi-copter 10 will be described below.

Each rotor 14 includes a motor and a blade mounted on the output shaft of the motor. The ESC 24 is connected to the motor of the rotor 14 and rotates the motor at a speed specified by the flight controller FC.

The flight controller FC includes: the receiver 32, which receives a manipulation signal from an operator (operator terminal 31); and a control device 20, which is a micro-controller connected to the receiver 32. The control device 20 includes: a CPU 21, which is a central processing unit; a memory 22, which is a storage device such as ROM, RAM, and flash memory; and a PWM (Pulse Width Modulation) controller 23, which controls the number of rotations of the rotors 14 via the ESC 24.

The flight controller FC further includes a flight control sensor group 26 and a GPS antenna 27 (these will be hereinafter occasionally referred to as “sensors”). These sensors are connected to the control device 20. The GPS antenna 27 is, in a strict sense, a receiver of a Navigation Satellite System (NSS). The GPS antenna 27 obtains, from a Global Navigation Satellite System (GNSS) or a Regional Navigation Satellite System (RNSS), information on present longitude and latitude values and present time. The flight control sensor group 26 of the multi-copter 10 of this example includes: an IMU (Inertial Measurement Unit) that includes a three-axis acceleration sensor and a three-axis angular velocity sensor; a pneumatic sensor (altitude sensor); and a geomagnetic sensor (direction sensor). The control device 20 is capable of obtaining, from these sensors, how much the airframe is inclined or turning, latitude and longitude of the airframe on flight, altitude, and position information of the airframe including nose azimuth.

The memory 22 of the control device 20 stores a flight control program FOP, in which an algorithm for controlling the posture of the multi-copter 10 during flight and controlling basic flight operations is described. In response to an instruction from the operator, the flight control program FCP adjusts the number of rotations of each rotor 14 based on information obtained from the sensors so as to correct the posture and/or position of the airframe while the multi-copier 10 is making a flight.

The multi-copter 10 may be manipulated manually by the operator using the operator terminal 31. Another possible example is to register a flight plan FP in an autonomous flight program APP in advance, the flight plan FP being parameters such as flight path, speed, and altitude of the multi-copter 10, and then to cause the multi-copter 10 to fly autonomously to a destination (this kind of autonomous flight will be hereinafter referred to as “autopilot”).

Thus, the multi-copier 10 according to this embodiment has high-level flight control functions. It is to be noted, however, that the unmanned aerial vehicle according to the present invention will not be limited in form to the multi-copter 10; for example, it is also possible to use an airframe with some of the sensors omitted or an airframe without autopilot function and capable of flying only by manual manipulation.

### (Air Bag Function)

The air bag device A includes an IMU 73, which is dedicated to the air bag device A and different from the IMU included in the flight control sensor group 26 of the flight controller FC. That is, the air bag device A of this example includes its own abnormality detection sensor to detect a collision and a fall of the multi-copter 10.

Output values of the IMU 73 are monitored by a control device 72, which is included in the air bag device A. When an output value of the IMU 73 has exhibited a change in excess of a predetermined threshold, the control device 72 determines this change as a collision or a fall of the multi-copter 10, and operates the inflator 600.

It is to be noted that the abnormality detection sensor of the air bag device A will not be limited in form to the IMU 73; insofar as the abnormality detection sensor is capable of detecting a collision or a fall of the multi-copter 10, the abnormality detection sensor may be made up of an acceleration sensor or an angular velocity sensor alone, or may be a combination of the IMU 73 and another sensor such as an altitude sensor.

The air bag device A also includes a battery 79, which serves as a motive power source of the servo motor 630, the control device 72, and the IMU 73. The battery 79 is dedicated to the air bag device A and different from the battery 19 of the flight controller FC. When an abnormality has occurred in the airframe B of the multi-copier 10, it is possible that the instrument and/or the motive power source provided in the airframe B is not operating normally. The air bag device A of this example is provided with: the IMU 73, which is a dedicated abnormality detection sensor; and the battery 79, which is a dedicated motive power source. This ensures that the laser scanner 8 is protected more

An embodiment of the present invention has been described hereinbefore. The present invention, however, will not be limited to the above-described embodiment but may have various modifications without departing from the scope of the present invention. For example, in the above-described embodiment, the inflated buffers 511 to 516 and 521 to 526 are aligned circumferentially along the upper, lower, right, and left side surfaces of the laser scanner 8. Another possible example is that these buffers are shorter in form than in the above-described embodiment and aligned along the upper, lower, right, and left side surfaces of the laser scanner 8.

1. An unmanned aerial vehicle comprising:
a plurality of rotary wings;
a load object disposed on an airframe of the unmanned aerial vehicle, the load object being an external device or a piece of goods disposed at an outside of the airframe; and
an air bag device configured to protect the load object,
wherein the air bag device comprises
a sensor configured to detect a collision and/or a fall of the airframe,
an air bag inflatable by a supply of gas, and
an inflator configured to supply the gas to the air bag,
wherein the air bag comprises a plurality of buffers each being a bag body inflatable into an approximately columnar shape, and
wherein the plurality of inflated buffers are aligned closely with each other in their radial direction along an outer surface of the load object.

2. The unmanned aerial vehicle according to claim 1, wherein at least one end portion of each buffer of the plurality of buffers is tapered, and a vicinity portion of the each buffer near the one end portion is curved or bent toward the load object.

3. The unmanned aerial vehicle according to claim 2, wherein the one end portion and another end portion of the each buffer are tapered, and vicinity portions of the each buffer near the one end portion and the another end portion are curved or bent toward the load object.

4. The unmanned aerial vehicle according to claim 1,
wherein the plurality of buffers in uninflated state are folded and stored in a plurality of storages, and
wherein the plurality of storages are oriented in a same direction and disposed at positions where the plurality of storages are line-symmetrical to each other with respect to, as a reference, an imaginary line passing through the load object.

5. The unmanned aerial vehicle according to claim 1,
wherein the plurality of buffers in uninflated state are folded and stored in a storage,
wherein the storage is a case body having such a structure that a pair of half bodies of the case body are bound to each other with a catch, and
wherein the catch has such a binding strength that the catch is releasable by inflation pressure of the plurality of buffers.

6. The unmanned aerial vehicle according to claim 1, wherein the air bag device comprises a partition that is a rigid member for regulating an inflation direction of each buffer of the plurality of buffers.

7. The unmanned aerial vehicle according to claim 6, wherein the partition is inserted between one buffer of the plurality of buffers and another buffer of the plurality of buffers adjacent to the one buffer.

8. The unmanned aerial vehicle according to claim 1,
wherein the inflator comprises
a gas canister filled with the gas,
a needle unit biased toward a sealed outlet of the gas canister,
a locking piece configured to lock movement of the needle unit, and
a servo motor configured to move the locking piece, and
wherein when the sensor has detected the collision and/or the fall of the airframe, the air bag device is configured to drive the servo motor in one direction to release a locked state of the needle unit.

9. The unmanned aerial vehicle according to claim 1,
wherein the sensor is a sensor dedicated to the air bag device and different from a sensor with which the airframe is equipped, and
wherein the air bag device comprises a motive power source that is dedicated to the air bag device and that is different from a motive power source with which the airframe is equipped.

10. The unmanned aerial vehicle according to claim 1, wherein the load object is a laser scanner configured to measure a topography.

11. The air bag device according to claim 1.

12. The air bag device according to claim 2.

13. The air bag device according to claim 3.

14. The air bag device according to claim 4.

15. The air bag device according to claim 5.

16. The air bag device according to claim 6.

17. The air bag device according to claim 7.

18. The air bag device according to claim 8.

19. The air bag device according to claim 9.

20. The air bag device according to claim 10.
